(19) United States
(12) Patent Application Publication
(10) Pub. No.: US 2016/0340209 A1
(43) Pub. Date: Nov. 24, 2016

(54) WATER TREATMENT APPARATUS AND WATER TREATMENT METHOD USING THE SAME

(71) Applicant: SUMITOMO ELECTRIC INDUSTRIES, LTD., Osaka-shi, Osaka (JP)

(72) Inventor: Hideki KASHIHARA, Osaka (JP)

(73) Assignee: SUMITOMO ELECTRIC INDUSTRIES, LTD., Osaka-shi, Osaka (JP)

(21) Appl. No.: 15/106,925

(22) PCT Filed: Feb. 23, 2015
(86) PCT No.: PCT/JP2015/055004

§ 371 Date: Jun. 21, 2016

(30) Foreign Application Priority Data
Mar. 17, 2014 (JP) 2014-054031

(51) Int. Cl. C02F 1/28; B01D 24/46; C02F 1/00; B01D 24/10

(52) U.S. Cl. CPC C02F 1/28; B01D 24/10; B01D 24/4631; C02F 1/004; C02F 2101/32

(57) ABSTRACT

An object is to provide a water treatment apparatus having a simple structure for cleaning treatment layers and having a low production cost, and a water treatment method using the water treatment apparatus. The water treatment apparatus of the present invention includes a tubular main body disposed in a lateral direction, in which an untreated liquid is supplied from one end side of the main body in an axial direction, and a treated liquid is discharged from another end side thereof. The water treatment apparatus includes a cleaning fluid supply unit that is connected to a lower circumferential surface of the main body and that supplies a cleaning fluid to an inside of the main body, and a cleaning fluid collecting unit that is connected to an upper circumferential surface of the main body and that collects the cleaning fluid from the inside of the main body. The main body includes a plurality of treatment layers which are partitioned along the axial direction and in which a plurality of particles are enclosed.

### TECHNICAL FIELD

The present invention relates to a water treatment apparatus and a water treatment method using the same.

### BACKGROUND ART

Oil-water mixed liquids containing oil and suspended substances and generated in oilfields, factories, and the like need to be disposed of after the amount of oil and suspended substances mixed is reduced to a certain value or less from the viewpoint of environmental conservation. Examples of the method for separating and removing oil and suspended substances from a mixed liquid include gravity separation, distillation separation, and chemical separation. An example of a method for separating and removing oil and suspended substances at a low cost is a method using a treatment layer in which particles are enclosed.

A water treatment apparatus using such a treatment layer separates oil and suspended substances in an oil-water mixed liquid by using particles in the treatment layer and discharges water from which the oil and suspended substances have been removed (refer to Japanese Unexamined Patent Application Publication No. 5-154309). When such a water treatment apparatus treats an oil-water mixed liquid containing, for example, an emulsion of oil and suspended substances having various sizes, the water treatment apparatus includes a plurality of treatment layers containing particles having different sizes.

In the existing water treatment apparatus described above, oil droplets and suspended substances are accumulated in the treatment layer. Therefore, when oil droplets and suspended substances are accumulated in the treatment layer to a certain degree, it is necessary to clean the particles in the treatment layer. For this cleaning, in general, cleaning by feeding a cleaning fluid such as water from a lower part of the treatment layer toward an upper part thereof and air scrubbing by feeding air bubbles are performed either simultaneously or separately.

### CITATION LIST

### Patent Literature

PTL 1: Japanese Unexamined Patent Application Publication No. 5-154309

### SUMMARY OF INVENTION

### Technical Problem

In the existing water treatment apparatus including a plurality of treatment layers, the treatment layers are arranged in a vertical direction. Accordingly, when cleaning is performed from a lower portion toward an upper portion (or the opposite thereof) without further treatment, a cleaning fluid containing suspended substances after cleaning flows into an upper layer (or a lower layer). Therefore, it is necessary to provide, for example, a pipe arrangement configured to separately perform cleaning of respective treatment layers. Accordingly, with an increase in the number of treatment layers, the water treatment apparatus becomes complicated, resulting in an increase in the production cost of the water treatment apparatus. In addition, since the cleaning is separately performed for respective treatment layers, it takes a time for the cleaning.

The present invention has been made in view of the circumstances described above. An object of the present invention is to provide a water treatment apparatus which has a simple structure for cleaning treatment layers and in which the cleaning time of the treatment layers can be reduced, and a water treatment method using the water treatment apparatus.

### Solution to Problem

An invention made in order to achieve the above object is a water treatment apparatus including a tubular main body disposed in a lateral direction, in which an untreated liquid is supplied from one end side of the main body in an axial direction, and a treated liquid is discharged from another end side thereof. The water treatment apparatus includes a cleaning fluid supply unit that is connected to a lower circumferential surface of the main body and that supplies a cleaning fluid to an inside of the main body, and a cleaning fluid collecting unit that is connected to an upper circumferential surface of the main body and that collects the cleaning fluid from the inside of the main body. The main body includes a plurality of treatment layers which are partitioned along the axial direction and in which a plurality of particles are enclosed.

Another invention made in order to achieve the above object is a water treatment method including a step of supplying an untreated liquid to the water treatment apparatus, and discharging a treated liquid.

### Advantageous Effects of Invention

The water treatment apparatus of the present invention has a simple structure for cleaning treatment layers, and thus the cleaning time of the treatment layers can be reduced. Therefore, according to the water treatment apparatus of the present invention and the water treatment method using the apparatus, an oil-water mixed liquid containing various suspended substances in addition to oil can be efficiently subjected to a separation treatment.

### BRIEF DESCRIPTION OF DRAWINGS

FIG. 1 is a schematic end face view illustrating a water treatment apparatus according to an embodiment of the present invention.

FIG. 2 is a schematic end face view illustrating a water treatment apparatus according to an embodiment different from the embodiment in FIG. 1.

FIG. 3 is a schematic end face view illustrating a water treatment apparatus according to an embodiment different from the embodiments in FIGS. 1 and 2.

### DESCRIPTION OF EMBODIMENTS

### Description of Embodiments of the Present Invention

A water treatment apparatus of the present invention includes a tubular main body disposed in a lateral direction, in which an untreated liquid is supplied from one end side of the main body in an axial direction, and a treated liquid is discharged from another end side thereof. The water treatment apparatus includes a cleaning fluid supply unit that is connected to a lower circumferential surface of the main body and that supplies a cleaning fluid to an inside of the main body, and a cleaning fluid collecting unit that is connected to an upper circumferential surface of the main body and that collects the cleaning fluid from the inside of the main body. The main body includes a plurality of treatment layers which are partitioned along the axial direction and in which a plurality of particles are enclosed.

In the water treatment apparatus, a direction in which the untreated liquid flows (lateral direction) is different from a direction in which the cleaning fluid flows (vertical direction). Therefore, it is possible to prevent the cleaning fluid after cleaning of a certain treatment layer, the cleaning fluid containing suspended substances, from flowing in another treatment layer disposed on the downstream side or the upstream side. Accordingly, it is not necessary to provide, for example, a complicated pipe arrangement for separately performing cleaning of respective treatment layers, and thus the structure for cleaning treatment layers can be simplified. Therefore, the water treatment apparatus is easily designed, and the production cost of the water treatment apparatus can be reduced. In the water treatment apparatus, cleaning need not be separately performed for respective treatment layers, and thus the cleaning time of the treatment layers can be reduced.

The treatment layers preferably have spaces above the particles. When the treatment layers have spaces above the particles in this manner, the particles easily flow during cleaning of the treatment layers, and thus the cleaning efficiency improves.

The spaces of the treatment layers are preferably separated from each other by a wall portion that does not allow a fluid to permeate. When the spaces of the treatment layers are separated from each other by a wall portion that does not allow a fluid to permeate in this manner, the untreated liquid more reliably passes through particle layers formed by the plurality of particles enclosed in the treatment layers, thus preventing the untreated liquid from passing through the treatment layers without being sufficiently filtered.

A flow path of a fluid of each of the treatment layers to an adjacent treatment layer is preferably formed in a zigzag manner in a vertical direction. In this manner, when a flow path of a fluid of each of the treatment layers to an adjacent treatment layer is formed in a zigzag manner in a vertical direction, the flow path of the untreated liquid is extended, and the water treatment efficiency improves.

The treatment layers are preferably inclined with respect to the axial direction of the main body. When the treatment layers are inclined with respect to the axial direction of the main body in this manner, the flow path of the untreated liquid is extended, and the water treatment efficiency improves. In addition, since the height of each particle layer is decreased by providing an inclination to the particle layer, the cleaning efficiency with the cleaning fluid from a lower portion toward an upper portion improves.

The water treatment apparatus preferably further includes a gap layer which is disposed between the treatment layers and in which no particles are enclosed. In this manner, when the water treatment apparatus further includes a gap layer which is disposed between the treatment layers and in which no particles are enclosed, a path is formed through which the cleaning liquid fed from a lower portion flows not only from lower portions of the treatment layers but also from a lateral portion through the gap layer. Consequently, the particles are more significantly stirred, and the cleaning efficiency improves.

An introduction pipe that introduces the cleaning fluid into the cleaning fluid supply unit is preferably connected to one of an untreated liquid supply side and a treated liquid discharge side of the main body, and a collection pipe that collects the cleaning fluid from the cleaning fluid collecting unit is preferably connected to the other of the untreated liquid supply side and the treated liquid discharge side of the main body. When the introduction pipe is connected to one of the untreated liquid supply side and the treated liquid discharge side of the main body, and the collection pipe is connected to the other of the untreated liquid supply side and the treated liquid discharge side of the main body in this manner, the cleaning fluid flows smoothly in the main body in one direction, and retention of the cleaning fluid is unlikely to occur in the main body. Thus, oil droplets, suspended substances, etc. separated from respective particles are unlikely to accumulate in the main body, and the cleaning efficiency improves.

Accordingly, for an untreated liquid containing oil and a suspended substance, the water treatment apparatus can be suitably used as an apparatus for obtaining treated water from which the oil and the suspended substance have been separated.

Another invention provides a water treatment method including a step of supplying an untreated liquid to the water treatment apparatus, and discharging a treated liquid.

According to the water treatment method, since an untreated liquid is treated using the water treatment apparatus, the production cost of the water treatment apparatus can be reduced. Furthermore, since the cleaning need not be separately performed for respective treatment layers, the cleaning time of the treatment layers can be reduced. Thus, according to the water treatment method using the water treatment apparatus of the present invention, an oil-water mixed liquid containing various suspended substances in addition to oil can be separated efficiently.

Herein, the term “space” of a treatment layer refers to a region between a partition plate formed above a plurality of particles in the treatment layer and a surface of a particle layer.

### Details of Embodiments of the Present Invention

Water treatment apparatuses and water treatment methods according to embodiments of the present invention will be described in detail.

### First Embodiment

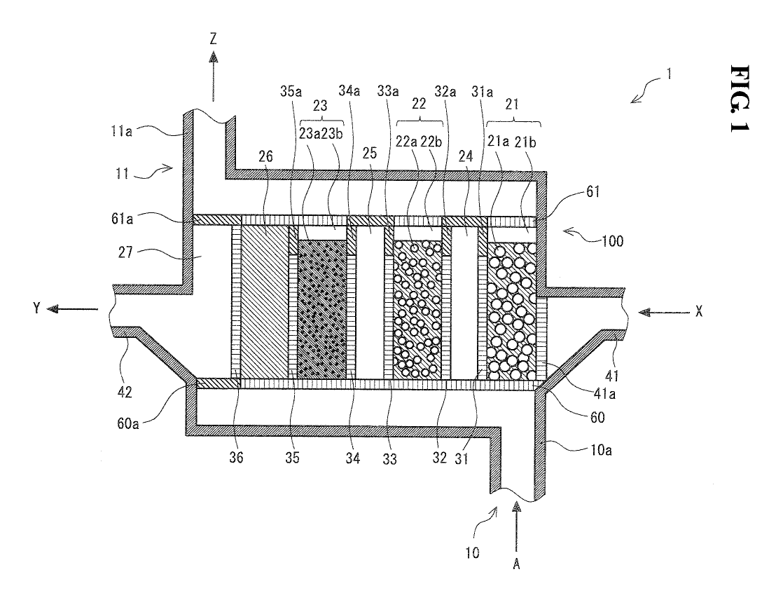

A water treatment apparatus 1 illustrated in FIG. 1 includes a tubular main body 100 disposed in a lateral direction. An untreated liquid X to be treated is supplied from one end side (the right side in the figure) of the main body 100 in an axial direction. A treated liquid Y is discharged from another end side (the left side in the figure) thereof. The water treatment apparatus 1 includes a cleaning fluid supply unit 10 that is connected to a lower circumferential surface of the main body 100 and that supplies a cleaning fluid A to an inside of the main body 100, and a cleaning fluid collecting unit 11 that is connected to an upper circumferential surface of the main body and that collects a cleaning fluid Z, which has been used in cleaning, from the inside of the main body 100. The main body 100 includes a plurality of treatment layers (a first treatment layer 21, a second treatment layer 22, and a third treatment layer 23) which are partitioned along the axial direction and in which a plurality of particles 21a, 22a, and 23a are enclosed, respectively. The main body 100 further includes gap layers (a first gap layer 24 and a second gap layer 25) in which no particles are enclosed, the gap layers being disposed between the first treatment layer 21 and the second treatment layer 22 and between the second treatment layer 22 and the third treatment layer 23, respectively.

The main body 100 further includes a fourth treatment layer 26 in which an adsorbent that adsorbs oil is enclosed, and a header portion 27. The first treatment layer 21, the first gap layer 24, the second treatment layer 22, the second gap layer 25, the third treatment layer 23, the fourth treatment layer 26, and the header portion 27 are arranged in series in that order from the one end side to which the untreated liquid X is supplied. These layers and the header portion are partitioned by partition plates 31 to 36.

The water treatment apparatus 1 can be suitably used for an untreated liquid containing oil and suspended substances. The suspended substances contain, for example, sand, particles of silica, calcium carbonate, etc., an iron powder, microorganisms, wood chips, and the like.

### (Main Body)

The main body 100 has a tubular shape, and a central axis thereof is arranged in a lateral direction (horizontal direction). A supply pipe 41 that supplies the untreated liquid X is connected to one side of the main body 100 in the axial direction. A discharge pipe 42 that discharges the treated liquid Y is connected to the other side.

The material of the main body 100 is not particularly limited, and a metal, a synthetic resin, or the like can be used.

In particular, from the viewpoint of strength, heat resistance, chemical resistance, etc., a stainless steel or an acrylonitrile-butadiene-styrene copolymer (ABS resin) is preferable. When higher strength and higher heat resistance are required, a fiber-reinforced plastic (FRP) is preferable. For example, an FRP that contains glass fibers, carbon fibers, or the like as fibers and an epoxy resin as a resin may be used.

A cross-sectional shape of the main body 100 perpendicular to the axial direction is not particularly limited, and may be a circle, a rectangle, or the like. When the cross-sectional shape of the main body 100 is a circle, the main body 100 does not have corners therein, and thus clogging of particles and the like in corners can be prevented. This structure is also advantageous in that the strength of the main body 100 is easily designed. On the other hand, when the cross-sectional shape of the main body 100 is a rectangle, the main body 100 is easily produced to reduce the cost. In addition, during cleaning, cleaning water and air can be easily uniformly supplied from a lower portion of each treatment layer.

The size of the main body 100 can be appropriately designed in accordance with the amount of untreated liquid to be treated. The diameter (the length of a side in the case of a rectangle) of the main body 100 may be, for example, 0.5 m or more and 5 m or less. The length of the main body 100 in the axial direction may be, for example, 0.5 m or more and 10 m or less.

The main body 100 preferably includes a partition plate 41a (supply portion partition plate 41a) that prevents particles 21a (first particles 21a) of the first treatment layer 21 from flowing out, the partition plate 41a being disposed in a region connected to the supply pipe 41. That is, the supply portion partition plate 41a has a structure through which the first particles 21a do not pass but a liquid can pass. Specifically, the supply portion partition plate 41a has a mesh (net) structure.

The materials of the supply pipe 41 and the discharge pipe 42 that are connected to the main body 100 are not particularly limited but may be the same as the material of the main body 100. The cross-sectional areas of the supply pipe 41 and the discharge pipe 42 preferably become larger toward the side connected to the main body 100. With the cross-sectional areas that become larger toward the side connected to the main body 100 in this manner, when the untreated liquid X is supplied to the water treatment apparatus 1, the flow velocity of the untreated liquid X decreases, and the water treatment efficiency improves.

(Treatment Layers in which a Plurality of Particles are Enclosed)

The plurality of treatment layers 21, 22, and 23 in which the plurality of particles 21a, 22a, and 23a are respectively enclosed are arranged in the order of the first treatment layer 21, the second treatment layer 22, and the third treatment layer 23 from the upstream side of the inside of the main body 100. The plurality of particles 21a, 22a, and 23a form particle layers in the treatment layers 21, 22, and 23, respectively. For example, the first treatment layer 21 mainly removes oil droplets and suspended substance particles having relatively large particle diameters and contained in the untreated liquid X. The second treatment layer 22 mainly removes oil droplets and suspended substance particles having medium particle diameters and contained in the untreated liquid X. The third treatment layer 23 mainly removes fine oil droplets and fine suspended substances contained in the untreated liquid X.

The length (width) of each of the treatment layers 21, 22, and 23 in the axial direction of the main body 100 is not particularly limited but may be, for example, 100 mm or more and 300 mm or less.

The lower limit of an average diameter of the first particles 21a is preferably 200 vin, more preferably 250 μm, and still more preferably 300 μm. The upper limit of the average diameter of the first particles 21a is preferably 500 μm, more preferably 450 and still more preferably 400 μm. When the average diameter of the first particles 21a is less than the lower limit, the particles enclosed in the first treatment layer 21 have a high density, which may result in an increase in the cost and the weight of the water treatment apparatus 1. When the average diameter of the first particles 21a exceeds the upper limit, the performance for removing oil droplets and suspended substance particles having relatively large particle diameters may be insufficient.

An average diameter of the second particles 22a is smaller than the average diameter of the first particles 21a. The lower limit of the average diameter of the second particles 22a is preferably 100 μm, more preferably 120 μm, and still more preferably 140 μm. The upper limit of the average diameter of the second particles 22a is preferably 300 μm, more preferably 250 μm, and still more preferably 200 μm. When the average diameter of the second particles 22a is less than the lower limit, the particles enclosed in the second treatment layer 22 have a high density, which may result in an increase in the cost and the weight of the water treatment apparatus 1. When the average diameter of the second particles 22a exceeds the upper limit, the performance for removing oil droplets and suspended substances having medium particle diameters may be insufficient.

An average diameter of the third particles 23a is smaller than the average diameter of the second particles 22a. The lower limit of the average diameter of the third particles 23a is preferably 10 μm, more preferably 20 μm, and still more preferably 30 μm. The upper limit of the average diameter of the third particles 23a is preferably 100 μm, more preferably 80 μm, and still more preferably 60 μm. When the average diameter of the third particles 23a is less than the lower limit, the particles enclosed in the third treatment layer 23 have a high density, which may result in an increase in the cost and the weight of the water treatment apparatus 1. When the average diameter of the third particles 23a exceeds the upper limit, the performance for removing fine oil droplets and fine suspended substances may be insufficient.

The lower limit of a uniformity coefficient of the plurality of particles 21a, 22a, and 23a is preferably 1.1, and more preferably 1.3. The upper limit of the uniformity coefficient of the particles 21a, 22a, and 23a is preferably 1.8, and more preferably 1.6. When the uniformity coefficient of the particles 21a, 22a, and 23a is less than the lower limit, the variation in the particles becomes small, and the particles may not be deposited densely. When the uniformity coefficient of the particles 21a, 22a, and 23a exceeds the upper limit, the capacity for separating oil droplets and suspended substances may become uneven in each of the insides of the treatment layers 21, 22, and 23. The uniformity coefficient is a value obtained by D60/D10 where D60 represents an opening (particle diameter) of a sieve through which 60% by mass of particles pass, and D10 represents an opening (particle diameter) of a sieve through which 10% by mass of particles pass.

Publicly known particles for a filtration treatment can be used as the plurality of particles. Examples of the particles include particles containing, as a main component, sand, a polymer compound, a natural material, or the like.

Examples of the sand include anthracite, garnet, and manganese sand, all of which have a relatively large particle diameter; and diatomaceous earth which has a relatively small particle diameter. These may be used as a mixture of two or more.

Examples of the polymer compound include vinyl resins, polyolefins, polyurethanes, epoxy resins, polyesters, polyamides, polyimides, melamine resins, and polycarbonates. Among these, vinyl resins, polyurethanes, and epoxy resins, all of which have good water resistance, good oil resistance, and the like are preferable, and polyolefins, which have good adsorptivity, are more preferable. Furthermore, among polyolefins, polypropylene, which has particularly good oil adsorption capacity, is preferable. In the case of a polymer compound, irregular-shaped pulverized particles are preferably used. By using irregular-shaped pulverized particles, the particles can be deposited densely, the filtration efficiency can be improved, and lifting of particles can be prevented.

Natural materials that are sieved to adjust the particle size can be used. Examples of the natural material include walnut shells, sawdust, and natural fibers such as hemp.

Particles containing, as a main component, any of the polymer compounds mentioned above are preferably used as the plurality of particles 21a, 22a, and 23a. By using, as the particles 21a, 22a, and 23a, particles containing a polymer compound as a main component in this manner, the cost and the weight of the water treatment apparatus 1 can be reduced. In addition, since the density of the particles 21a, 22a, and 23a can be made low, the stirring effect during cleaning of the treatment layers can be enhanced.

The plurality of treatment layers 21, 22, and 23 include spaces 21b, 22b, and 23b (a first space 21b, a second space 22b, and a third space 23b) above the plurality of particles 21a, 22a, and 23a, respectively. Since the treatment layers 21, 22, and 23 include these spaces 21b, 22b, and 23b, respectively, during the cleaning of the treatment layers, the particles 21a, 22a, and 23a fly in the spaces 21b, 22b, and 23b, respectively, and stirred. Thus, the treatment layers 21, 22, and 23 can be cleaned effectively. Furthermore, some of oil and suspended substance particles separated in the treatment layers 21, 22, and 23 stay (are separated by floating) in the spaces 21b, 22b, and 23b, respectively, and are discharged together with the cleaning fluid Z during the cleaning of the treatment layers.

The lower limit of an average height of the spaces 21b, 22b, and 23b is preferably 5 cm, and more preferably 20 cm. The upper limit of the average height is preferably 40 cm, and more preferably, 30 cm. When the average height is less than the lower limit, the effect of cleaning the treatment layers 21, 22, and 23 may not be sufficiently obtained. When the average height exceeds the upper limit, the heights of the particle layers of the particles 21a, 22a, and 23a may be excessively low, and the water treatment capacity may be insufficient. Herein, the term “average height” of the spaces means an average of the distance from the surfaces of the particle layers to a connecting portion 61 of the cleaning fluid collecting unit 11 described below.

### (Gap Layers)

The two gap layers 24 and 25 are layers which are disposed between the first treatment layer 21 and the second treatment layer 22 and between the second treatment layer 22 and the third treatment layer 23, respectively, and in which no particles are enclosed. When the gap layers 24 and 25, in which no particles are enclosed, are respectively arranged between the first treatment layer 21 and the second treatment layer 22 and between the second treatment layer 22 and the third treatment layer 23 in this manner, a path is formed through which a cleaning liquid fed from lower portions during cleaning flows not only from lower portions of the treatment layers 21, 22, and 23 but also from lateral portions through the gap layers 24 and 25. Consequently, the particles 21a, 22a, and 23a are more significantly stirred, and oil droplets, suspended substances, etc. which have been trapped can be more reliably separated and removed.

The length (width) of each of the gap layers 24 and 25 in the axial direction of the main body 100 is not particularly limited but may be, for example, 100 mm or more and 200 mm or less. A ratio of the width of a gap layer to the width of a treatment layer (width of gap layer/width of treatment layer) may be, for example, 1/5 or more and 1 or less.

### (Fourth Treatment Layer)

The fourth treatment layer 26 is arranged on the downstream side of the third treatment layer 23. An adsorbent that adsorbs oil is enclosed in the fourth treatment layer 26. This adsorbent forms a layer in the fourth treatment layer 26. The fourth treatment layer 26 mainly adsorbs and removes finer oil droplets that could not have been removed by the first treatment layer 21, the second treatment layer 22, and the third treatment layer 23.

Publicly known adsorbents for oil can be used as the adsorbent. Examples thereof include porous ceramics, non-woven fabrics, woven fabrics, fibers, and activated carbon. Among these, non-woven fabrics formed of a plurality of organic fibers are preferable. Such a non-woven fabric formed of a plurality of organic fibers adsorbs oil with the organic fibers, thereby performing oil-water separation. Therefore, in this non-woven fabric, the diameter of pores formed between the fibers need not be small, and the pores can have a large diameter. Accordingly, clogging of the pores with high-viscosity oil is suppressed, and an increase in the pressure loss can be suppressed.

A main component of the organic fibers that form the non-woven fabric is not particularly limited as long as the main component is an organic resin that can adsorb oil. Examples thereof include cellulose resins, rayon resins, polyester, polyurethanes, polyolefins (such as polyethylene and polypropylene), polyamides (such as aliphatic polyamides and aromatic polyamides), acrylic resins, polyacrylonitrile, polyvinyl alcohol, polyimides, silicone resins, and fluororesins. Among these, fluororesins or polyolefins are preferable. Heat resistance and chemical resistance of the non-woven fabric can be enhanced by using organic fibers containing a fluororesin as a main component. Furthermore, among fluororesins, polytetrafluoroethylene, which has particularly good heat resistance etc., is preferable. Oil adsorption capacity of the non-woven fabric can be enhanced by using organic fibers containing a polyolefin as a main component. Furthermore, among polyolefins, polypropylene, which has particularly good oil adsorption capacity, is preferable. The material for forming the organic fibers may contain other polymers, additives such as a lubricant, and the like as required.

The upper limit of an average diameter of the organic fibers is preferably 1 μm, more preferably 0.9 μm, and still more preferably 0.1 μm. The lower limit of the average diameter of the organic fibers is preferably 10 nm. When the average diameter of the organic fibers exceeds the upper limit, the organic fibers have a small surface area per unit volume. Accordingly, in order to ensure a certain oil adsorption capacity, it is necessary to increase the fiber density. As a result, a pore diameter and a porosity of the non-woven fabric are reduced, and clogging with oil easily occurs. In particular, when the untreated liquid X contains fuel oil C, the fuel oil C can be adsorbed more reliably by setting the average diameter of the organic fibers to the upper limit or less because the particle diameter of the fuel oil C dispersed and contained in water tends to become about 0.1 to 1.0 μm. When the average diameter of the organic fibers is less than the lower limit, it may be difficult to form a non-woven fabric, and the strength of the non-woven fabric may be insufficient.

The lower limit of the porosity of the non-woven fabric is preferably 80%, more preferably 85%, and still more preferably 88%. The upper limit of the porosity of the non-woven fabric is preferably 99%, and more preferably 95%. When the porosity of the non-woven fabric is less than the lower limit, the amount of untreated liquid treated with the non-woven fabric may decrease, and pores of the non-woven fabric are easily clogged with oil. When the porosity of the non-woven fabric exceeds the upper limit, the strength of the non-woven fabric may not be maintained.

The lower limit of an average pore diameter of the non-woven fabric is preferably 1 μm, more preferably 2 μm, and still more preferably 5 μm. The upper limit of the average pore diameter of the non-woven fabric is preferably 20 μm, and more preferably 8 μm. When the average pore diameter of the non-woven fabric is less than the lower limit, the amount of untreated liquid treated with the non-woven fabric may decrease, and pores of the non-woven fabric are easily clogged with oil.

When the average pore diameter of the non-woven fabric exceeds the upper limit, the oil adsorption function of the non-woven fabric may decrease, and the strength of the non-woven fabric may not be maintained.

The fourth treatment layer 26 may be formed by filling the main body 100 with a plurality of fibers. Long fibers having an average diameter of 1 μm or less are preferably used as the fibers.

The length of the fourth treatment layer 26 in the axial direction of the main body 100 is not particularly limited but may be, for example, 10 mm or more and 100 mm or less.

### (Partition Plates)

The partition plates 31 to 36 are plates that are disposed between the treatment layers and that prevent the particles 21a, 22a, and 23a and the adsorbent from flowing out. Similarly to the supply portion partition plate 41a, the partition plates 31 to 36 each have a mesh structure.

The material of the partition plates 31 to 36 and the partition plate 41a is not particularly limited, and a metal, a synthetic resin, or the like can be used. When a metal is used, from the viewpoint of corrosion prevention, a stainless steel (in particular, SUS 316L) is preferably used. When a synthetic resin is used, a supporting member such as a reinforcing wire is preferably used in combination so that the opening is not changed by the water pressure and the weight of the particles.

The nominal opening of the mesh of each of the supply portion partition plate 41a and the partition plate 31 (first partition plate 31) disposed between the gap layer 24 and the first treatment layer 21 is designed so as to be equal to or less than a minimum diameter of the plurality of first particles 21a (a maximum opening of a sieve through which the first particles 21a do not pass). The upper limit of the nominal opening of the mesh of the first partition plate 31 is preferably 200 μm, and more preferably 180 μm. The lower limit of the nominal opening is preferably 10 μm, and more preferably 80 μm. When the nominal opening exceeds the upper limit, the first particles 21a may pass through the supply portion partition plate 41a and the first partition plate 31. When the nominal opening is less than the lower limit, the flow velocity of the untreated liquid is excessively decreased by the pressure loss. Thus, the treatment efficiency of the water treatment apparatus may become insufficient.

The nominal opening of the mesh of each of the partition plate 32 (second partition plate 32) disposed between the gap layer 24 and the second treatment layer 22 and the partition plate 33 (third partition plate 33) disposed between the second treatment layer 22 and the gap layer 25 is designed so as to be equal to or less than a minimum diameter of the plurality of second particles 22a (a maximum opening of a sieve through which the second particles 22a do not pass). The upper limit of the nominal opening of the mesh of each of the second partition plate 32 and the third partition plate 33 is preferably 100 μm, and more preferably 80 μm. The lower limit of the nominal opening is preferably 10 μm, and more preferably 40 μm. When the nominal opening exceeds the upper limit, the second particles 22a may pass through the second partition plate 32 and the third partition plate 33. When the nominal opening is less than the lower limit, the flow velocity of the untreated liquid is excessively decreased by the pressure loss. Thus, the treatment efficiency of the water treatment apparatus may become insufficient.

The nominal opening of the mesh of the partition plate 34 (fourth partition plate 34) disposed between the gap layer 25 and the third treatment layer 23 is designed so as to be equal to or less than a minimum diameter of the plurality of third particles 23a (a maximum opening of a sieve through which the third particles 23a do not pass). The upper limit of the nominal opening of the mesh of the fourth partition plate 34 is preferably 80 μm, and more preferably 50 μm. The lower limit of the nominal opening is preferably 10 μm, and more preferably 20 μm. When the nominal opening exceeds the upper limit, the third particles 23a may pass through the fourth partition plate 34. When the nominal opening is less than the lower limit, the flow velocity of the untreated liquid is excessively decreased by the pressure loss. Thus, the treatment efficiency of the water treatment apparatus may become insufficient.

The nominal opening of the mesh of each of the partition plate 35 (fifth partition plate 35) disposed between the third treatment layer 23 and the fourth treatment layer 26 and the partition plate 36 (sixth partition plate 36) disposed between the fourth treatment layer 26 and the header portion 27 may have a size that can prevent the adsorbent from flowing out and can be appropriately designed in accordance with the type of adsorbent. It is also necessary that the fifth partition plate 35 prevent the third particles 23a from flowing out from the third treatment layer 23. Accordingly, the nominal opening of the mesh of the fifth partition plate is preferably smaller than the nominal opening of the mesh of the fourth partition plate 34.

The first partition plate 31, the second partition plate 32, the third partition plate 33, the fourth partition plate 34, and the fifth partition plate 35 that contact the first treatment layer 21, the second treatment layer 22, and the third treatment layer 23 having the spaces 21b, 22b, and 23b, respectively, have, on upper portions thereof, wall portions 31a, 32a, 33a, 34a, and 35a (a first wall portion 31a, a second wall portion 32a, a third wall portion 33a, a fourth wall portion 34a, and a fifth wall portion 35a, respectively) that do not allow a fluid to permeate. The first wall portion 31a separates the first space 21b of the first treatment layer 21 from the adjacent first gap layer 24. Since the first wall portion 31a separates the first space 21b of the first treatment layer 21 from the adjacent first gap layer 24 in this manner, it is possible to prevent the untreated liquid X from passing through the first space 21b and flowing in the first gap layer 24. Similarly, regarding the second wall portion 32a, the third wall portion 33a, the fourth wall portion 34a, and the fifth wall portion 35a, it is possible to prevent the untreated liquid X in each treatment layer from passing through a space in an upper position of the treatment layer and flowing in an adjacent treatment layer.

### (Header Portion)

The header portion 27 is arranged on the downstream side of the fourth treatment layer 26. The discharge pipe 42 that discharges the treated liquid Y is connected to the downstream side of the header portion 27. The treated liquid Y that has passed through the treatment layers is collected in the header portion 25 and then discharged.

### (Cleaning Fluid Supply Unit)

The cleaning fluid supply unit 10 is connected to a lower circumferential surface of the main body 100 and supplies a cleaning fluid A to the inside of the main body 100. Specifically, the cleaning fluid supply unit 10 includes an introduction pipe 10a that introduces the cleaning fluid A on the untreated liquid supply side (the right side in the figure) of the main body 100. The cleaning fluid supply unit 10 is disposed below the first treatment layer 21, the first gap layer 24, the second treatment layer 22, the second gap layer 25, the third treatment layer 23, the fourth treatment layer 26, and the header portion 27 of the main body 100 so as to extend over these. The cleaning fluid supply unit 10 is connected to the first treatment layer 21, the first gap layer 24, the second treatment layer 22, the second gap layer 25, the third treatment layer 23, the fourth treatment layer 26, and the header portion 27 with a partition plate 60 (fluid supply portion partition plate 60) therebetween.

The material of the cleaning fluid supply unit 10 is not particularly limited but may be the same material as that of the main body 100. The cleaning fluid supply unit 10 can be integrally formed with the main body 100 by, for example, partitioning a tubular body into the main body 100 and the cleaning fluid supply unit 10 with the fluid supply portion partition plate 60 therebetween.

The fluid supply portion partition plate 60 has a structure through which the first particles 21a, the second particles 22a, the third particles 23a, and the adsorbent do not pass but a liquid can pass. Specifically, the fluid supply portion partition plate 60 has a mesh structure. For example, the mesh of the fluid supply portion partition plate 60 may have a size that can prevent the smallest particle among the first particles 21a, the second particles 22a, the third particles 23a, and the adsorbent from flowing out, and the size can be appropriately designed in accordance with the types of particles. By making the nominal opening of the mesh of the fluid supply portion partition plate 60 have a size that can prevent the smallest particle from flowing out, the mesh of the fluid supply portion partition plate 60 can prevent the first particles 21a, the second particles 22a, the third particles 23a, and the adsorbent from falling on the cleaning fluid supply unit 10. The nominal opening of the mesh of the fluid supply portion partition plate 60 may be changed in each treatment layer to be connected as long as the first particles 21a, the second particles 22a, the third particles 23a, and the adsorbent do not fall on the cleaning fluid supply unit 10.

The fluid supply portion partition plate 60 has a wall portion 60a in a region connected to the header portion 27. This wall portion 60a prevents the cleaning fluid A from passing through the header portion 27, in which particles to be cleaned and the like are not present, and being collected in the cleaning fluid collecting unit 11, thus improving the cleaning efficiency. The wall portion 60a also prevents the untreated liquid X from flowing in the header portion 27 without being sufficiently filtered.

The introduction pipe 10a of the cleaning fluid supply unit 10 includes an opening/closing port (not shown) that can control the flowing of the cleaning fluid A in the cleaning fluid supply unit 10. During the cleaning of the treatment layers, the opening/closing port is opened to supply the cleaning fluid A to the cleaning fluid supply unit 10. In contrast, during the water treatment, the opening/closing port is closed to prevent the untreated liquid from flowing out from the main body 100 through the cleaning fluid supply unit 10.

The cleaning fluid A is supplied as a jet water stream to the introduction pipe 10a of the cleaning water supply unit 10 by, for example, being sent under pressure with a pump. This jet water stream passes through the fluid supply portion partition plate 60, forms an upward flow, causes the plurality of first particles 21a, second particles 22a, and third particles 23a to fly upward, and stirs the particles. Oil droplets, suspended substances, and the like trapped between the particles are separated by this stirring, and these flow to an upper portion of the water treatment apparatus 1. The oil droplets and suspended substances flowing upward are collected together with the cleaning fluid Z through the cleaning fluid collecting unit 11 described below. A water-supply pressure of the cleaning fluid A is preferably 0.2 MPa or more. A flux of the jet water stream in the fluid supply portion partition plate 60 is preferably 20 m/d or more.

The particles of each of the treatment layers may be cleaned by air scrubbing performed by feeding air bubbles from the introduction pipe 10a of the cleaning water supply unit 10. Specifically, after the cleaning fluid A is allowed to stay, air bubbles are fed to the main body 100. Substances adhering to the first particles 21a, the second particles 22a, and the third particles 23a are removed by scrubbing the surfaces of the particles 21a, 22a, and 23a with the air bubbles and further vibrating the first particles 21a, the second particles 22a, and the third particles 23a.

The cleaning with a jet water stream and the cleaning by air scrubbing may be performed simultaneously, but are preferably performed alternately. The cleaning effect is improved by alternately performing the cleaning with a jet water stream and the cleaning by air scrubbing.

The flow rate of the cleaning fluid may be, for example, double the amount of an untreated liquid supplied during the water treatment. The cleaning time of the treatment layers may be, for example, 30 seconds or more and 10 minutes or less. The cleaning interval may be, for example, 1 hour or more and 12 hours or less.

### (Cleaning Fluid Collecting Unit)

The cleaning fluid collecting unit 11 is connected to an upper circumferential surface of the main body 100 and collects the cleaning fluid Z from the inside of the main body 100. Specifically, the cleaning fluid collecting unit 11 includes a collection pipe 11a that collects the cleaning fluid Z on the untreated liquid discharge side (the left side in the figure) of the main body 100. The cleaning fluid collecting unit 11 is disposed above the first treatment layer 21, the first gap layer 24, the second treatment layer 22, the second gap layer 25, the third treatment layer 23, the fourth treatment layer 26, and the header portion 27 of the main body 100 so as to extend over these. The cleaning fluid collecting unit 11 is connected to the first treatment layer 21, the first gap layer 24, the second treatment layer 22, the second gap layer 25, the third treatment layer 23, the fourth treatment layer 26, and the header portion 27 with the connecting portion 61 therebetween.

The material of the cleaning fluid collecting unit 11 is not particularly limited but may be the same material as that of the cleaning fluid supply unit 10. The cleaning fluid collecting unit 11 can be integrally formed with the main body 100, for example, similarly to the cleaning fluid supply unit 10.

The collection pipe 11a preferably includes a control valve (not shown) that can control the pressure in the cleaning fluid collecting unit 11. The amounts of the cleaning fluid and air bubbles spreading to the respective layers can be controlled by adjusting the pressure in the cleaning fluid collecting unit 11 with the control valve, thus improving the cleaning efficiency.

The collection pipe 11a of the cleaning fluid collecting unit 11 includes an opening/closing port (not shown) that can control the collection of the cleaning fluid Z from the cleaning fluid collecting unit 11. During the cleaning of the treatment layers, the opening/closing port is opened to collect the cleaning fluid Z from the cleaning fluid collecting unit 11. In contrast, during the water treatment, the opening/closing port is closed to prevent the untreated liquid X from flowing out from the main body 100 through the cleaning fluid collecting unit 11.

The cleaning fluid collecting unit 11 is connected to the main body 100 through the connecting portion 61. The connecting portion 61 has a structure through which the first particles 21a, the second particles 22a, the third particles 23a, and the adsorbent do not pass but a liquid can pass. Specifically, the connecting portion 61 has a mesh structure. The connecting portion 61 having such a mesh structure can prevent the particles in the treatment layers from flowing out from the connecting portion 61. The nominal opening of the mesh of the connecting portion 61 may have a size that can prevent the smallest particle among these from flowing out, and can be appropriately designed in accordance with the types of particles.

The connecting portion 61 has wall portions 61a in regions connected to the first gap layer 24, the second gap layer 25, and the header portion 27. This wall portions 61a prevent the cleaning fluid A from passing through the first gap layer 24, the second gap layer 25, and the header portion 27, in which particles to be cleaned and the like are not present, and being collected in the cleaning fluid collecting unit 11, thus improving the cleaning efficiency. The wall portions 61a also prevent the untreated liquid X from bypassing the treatment layers and flowing in the header portion 27.

### (Advantages)

According to the water treatment apparatus 1, since the direction in which the untreated liquid X flows (lateral direction) is different from the direction in which the cleaning fluid A flows (vertical direction), it is possible to prevent the cleaning fluid Z after cleaning of a certain treatment layer, the cleaning fluid Z containing suspended substances, from flowing in another treatment layer disposed on the downstream side or the upstream side. Accordingly, it is not necessary to provide, for example, a complicated pipe arrangement for separately performing cleaning of respective treatment layers, and thus the structure for cleaning treatment layers can be simplified. Therefore, the water treatment apparatus is easily designed, and the production cost of the water treatment apparatus can be reduced. In the water treatment apparatus 1, cleaning need not be separately performed for respective treatment layers, and thus the cleaning time of the treatment layers can be reduced.

The introduction pipe 10a of the cleaning fluid supply unit 10 is connected to the untreated liquid supply side of the main body 100, and the collection pipe 11a of the cleaning fluid collecting unit 11 is connected to the treated liquid discharge side of the main body 100. Accordingly, the cleaning fluid flows smoothly from the upstream side to the downstream side in the main body 100, and retention of the cleaning fluid is unlikely to occur in the main body 100. Thus, oil droplets, suspended substances, etc. separated from respective particles are unlikely to accumulate in the main body 100, and the cleaning efficiency improves. Since the introduction pipe 10a is disposed on the upstream side, a stronger jet water stream is easily applied to the first particles 21a having large particle sizes. Thus, the cleaning effect can be further improved.

### <Water Treatment Method>

The water treatment method includes a step of supplying an untreated liquid to the water treatment apparatus and discharging a treated liquid.

The method for supplying an untreated liquid is not particularly limited. An example thereof that can be used is a method in which an untreated liquid is sent to the water treatment apparatus under pressure with a pump or a hydraulic head.

The lower limit of an amount of untreated liquid supplied in the water treatment method is preferably 100 m³/m²·day, more preferably 200 m³/m²·day, and still more preferably 300 m³/m²·day. When the untreated liquid has a high oil concentration, a high suspended substance concentration, and a high viscosity, a high water quality is obtained even at a treatment speed less than the lower limit, and a treatment can be performed at a sufficiently low cost. However, when the untreated liquid has low concentrations and a high-speed treatment is desired in terms of cost, if the amount of untreated liquid supplied is less than the lower limit, the water treatment method may not be suitable for use in an environment in which an untreated liquid is generated in a large amount.

The upper limit of the amount of untreated liquid supplied is not particularly limited but may be, for example, 1,000 m³/m²·day.

The upper limit of the suspended substance concentration of the treated liquid discharged by the water treatment method is preferably, 10 ppm, more preferably 5 ppm, still more preferably 3 ppm, and particularly preferably 1 ppm or less.

By setting the suspended substance concentration of the treated liquid to the upper limit or less, the treated liquid treated by the water treatment method can be disposed of without imposing a load to the environment and can be used as industrial water. The term “suspended substance concentration” means a concentration of suspended solids (SS) and refers to a value measured in accordance with “14.1 Suspended solids” in JIS-K0102 (2008).

The upper limit of the oil concentration of the treated liquid discharged by the water treatment method is preferably 100 ppm, more preferably 50 ppm, still more preferably 10 ppm, and particularly preferably 1 ppm or less. By setting the oil concentration of the treated liquid to the upper limit or less, the load of an oil-water separation treatment conducted after the water treatment method can be reduced, and, under some conditions, even if another oil-water separation treatment is not conducted, the treated liquid that has been subjected to oil-water separation by the water treatment method can be disposed of without imposing a load to the environment.

### (Advantages)

According to the water treatment method, since the untreated liquid X is treated using the water treatment apparatus 1, the production cost of the water treatment apparatus can be reduced. Furthermore, since the cleaning need not be separately performed for respective treatment layers, the cleaning time of the treatment layers can be reduced. Thus, according to the water treatment method, an oil-water mixed liquid containing various suspended substances in addition to oil can be separated efficiently.

### Second Embodiment

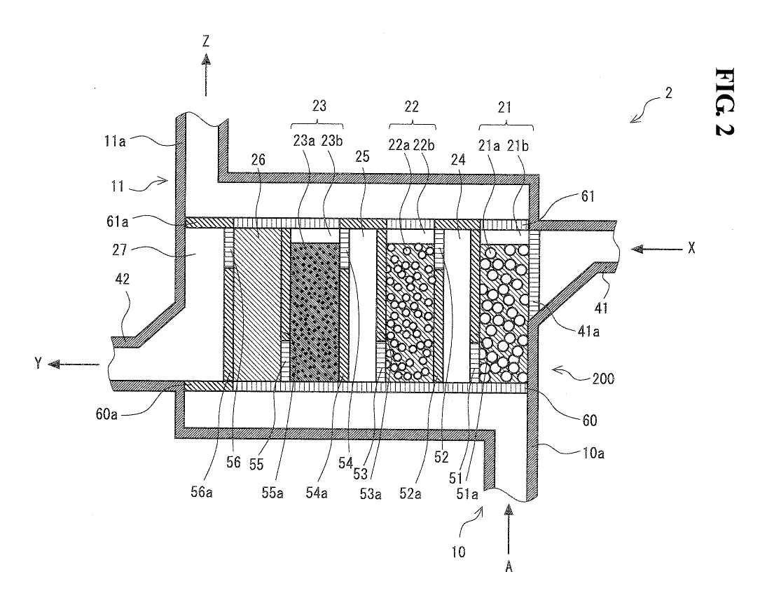

A water treatment apparatus 2 illustrated in FIG. 2 mainly includes a tubular main body 200 disposed in a lateral direction, a cleaning fluid supply unit 10, and a cleaning fluid collecting unit 11. The main body 200 includes a first treatment layer 21, a first gap layer 24, a second treatment layer 22, a second gap layer 25, a third treatment layer 23, a fourth treatment layer 26, and a header portion 27 that are arranged in series in that order from one end side to which an untreated liquid X is supplied. These layers and the header portion are partitioned by partition plates 51 to 56. In FIG. 2, parts the same as those in FIG. 1 are assigned the same reference numerals, and a description thereof is omitted.

### (Partition Plates)

In the water treatment apparatus 2, as illustrated in FIG. 2, a flow path of a fluid of the plurality of treatment layers 21, 22, and 23 to the adjacent gap layers 24 and 25 is vertically disposed in a zigzag manner. Specifically, the first partition plate 51 has a wall portion 51a on the upper side of the partition plate, and the second partition plate 52 has a wall portion 52a on the lower side of the partition plate. Similarly, the third partition plate 53 has a wall portion 53a on the upper side, the fourth partition plate 54 has a wall portion 54a on the lower side, the fifth partition plate 55 has a wall portion 55a on the upper side, and the sixth partition plate 56 has a wall portion 56a on the lower side. Thus, the wall portions are arranged in a zigzag formation. The partition plates 51 to 56 each have a mesh structure in a portion other than the wall portion. A supply pipe 41 is connected to the upper side of a side face of the main body 200. With this structure, the flow path of the water treatment apparatus 2 can be extended.

The lower limit of a ratio of the length of the wall portions 51a to 56a to the length of the partition plates 51 to 56 is preferably 0.5, and more preferably 0.6. The upper limit of the ratio of the length of the wall portions to the length of the partition plates is preferably 0.9, and more preferably 0.8. When the ratio of the length of the wall portions to the length of the partition plates is less than the lower limit, the flow velocity of the untreated liquid is excessively decreased by the pressure loss. Thus, the treatment efficiency of the water treatment apparatus may become insufficient. When the ratio of the length of the wall portions to the length of the partition plates exceeds the upper limit, the effect of extending the flow path of the untreated liquid X may not be sufficiently obtained.

### (Advantage)

According to the water treatment apparatus 2, since a flow path of a fluid of the plurality of treatment layers to the adjacent treatment layers is formed in a zigzag manner in the vertical direction, the untreated liquid X flows in the vertical direction in a meandering manner. Thus, the flow path is extended, and the water treatment efficiency improves.

In the above embodiment, the wall portions 51a to 56a are alternately formed in the order of an upper portion and a lower portion from the first partition plate 51 to the sixth partition plate 56. Alternatively, the wall portions 51a to 56a may be alternately formed in the opposite order, that is, in the order of a lower portion and an upper portion from the first partition plate 51 to the sixth partition plate 56. Also in this case, the same advantage is obtained.

### Third Embodiment

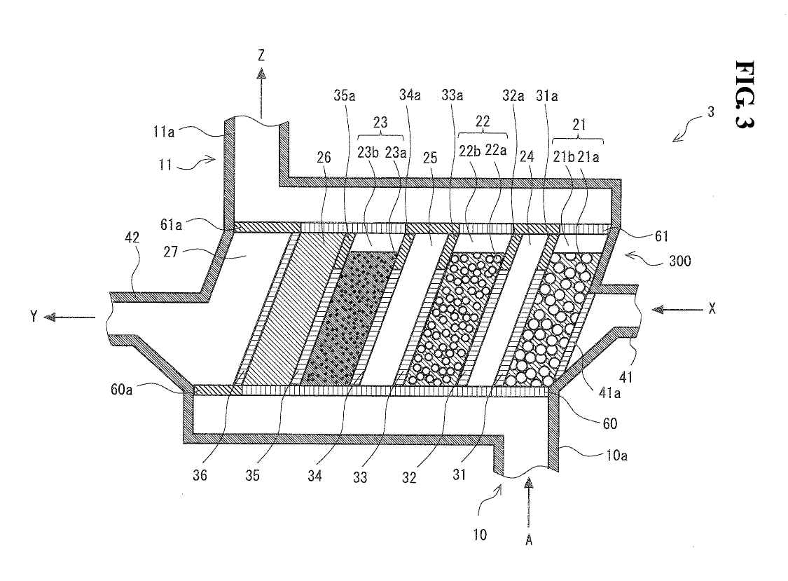

A water treatment apparatus 3 illustrated in FIG. 3 mainly includes a tubular main body 300 disposed in a lateral direction, a cleaning fluid supply unit 10, and a cleaning fluid collecting unit 11. The main body 300 includes a first treatment layer 21, a first gap layer 24, a second treatment layer 22, a second gap layer 25, a third treatment layer 23, a fourth treatment layer 26, and a header portion 27 that are arranged in series in that order from one end side to which an untreated liquid X is supplied. These layers and the header portion are partitioned by partition plates 31 to 36. In FIG. 3, parts the same as those in FIG. 1 are assigned the same reference numerals, and a description thereof is omitted.

### (Treatment Layers)

In the water treatment apparatus 3, as illustrated in FIG. 3, each treatment layer is inclined with respect to the axial direction of the main body 300 such that the upper side of the treatment layer is directed to the untreated liquid supply side. With this structure, the flow path of the water treatment apparatus 3 can be extended.

The lower limit of an angle of inclination of each of the treatment layers is preferably 10°, and more preferably 15°.

The upper limit of the angle of inclination of each of the treatment layers is preferably 30°, and more preferably 25°. When the angle of inclination of each of the treatment layers is less than the lower limit, the effect of extending the flow path may not be sufficiently obtained. The length of the main body 300 may become excessively large. When the angle of inclination of each of the treatment layers exceeds the upper limit, a cleaning fluid may easily flow into an adjacent treatment layer.

### (Advantages)

According to the water treatment apparatus 3, since the plurality of treatment layers are inclined with respect to the axial direction of the main body 300, the flow path of an untreated liquid is extended, and the water treatment efficiency improves. In addition, since the height of each particle layer is decreased by providing an inclination to the particle layer, the cleaning efficiency with the cleaning fluid from a lower portion toward an upper portion improves.

In the water treatment apparatus 3, each treatment layer is inclined such that the upper side of the treatment layer is directed to the untreated liquid supply side. Alternatively, each treatment layer may be inclined such that the upper side of the treatment layer is directed to the untreated liquid discharge side. Also in this case, the same advantages are obtained.

### Other Embodiments

It is to be understood that the embodiments disclosed herein are only illustrative and are not restrictive in all respects. The scope of the present invention is not limited to the structures of the embodiments but defined by the claims described below. It is intended that the scope of the present invention includes equivalents of the claims and all modifications within the scope of the claims.

The water treatment apparatuses of the above embodiments each include an introduction pipe of a cleaning fluid supply unit that introduces a cleaning fluid on the untreated liquid supply side of the main body, and a collection pipe of a cleaning fluid collecting unit that collects the cleaning fluid on the treated liquid discharge side of the main body. Alternatively, the water treatment apparatuses may include the introduction pipe on the treated liquid discharge side of the main body and the collection pipe on the untreated liquid supply side of the main body. When the introduction pipe is provided on the treated liquid discharge side of the main body and the collection pipe is provided on the untreated liquid supply side of the main body in this manner, the cleaning fluid flows from the downstream side to the upstream side in the main body. Therefore, cleaning is performed with a water stream in a direction opposite to a direction in which an untreated liquid flows, and thus the cleaning effect is enhanced.

The water treatment apparatuses of the above embodiments each include three treatment layers in which a plurality of particles are enclosed. Alternatively, the water treatment apparatuses may each include two treatment layers or four or more treatment layers.

In the water treatment apparatuses of the above embodiments, the average diameters of particles enclosed in the plurality of treatment layers decrease in the downstream direction from the layer on the upstream side. Alternatively, the average diameter of particles of a treatment layer on the downstream side may be substantially the same as or larger than the average diameter of particles of a treatment layer on the upstream side.

The water treatment apparatuses of the above embodiments each include the fourth treatment layer on the downstream side of the third treatment layer. However, the fourth treatment layer may be omitted when, for example, an untreated liquid has a low oil content. Alternatively, the header portion may not be provided and, for example, when the fourth treatment layer is provided, the fifth partition plate may be brought into contact with the discharge pipe.

In the water treatment apparatuses, the first space, the second space, and the third space formed in upper portions of the first treatment layer, the second treatment layer, and the third treatment layer, respectively, are not essential components and may be omitted as required. However, in order to effectively perform cleaning of the treatment layers, these spaces are preferably provided.

In the water treatment apparatuses, the gap layers disposed between the first treatment layer and the second treatment layer and between the second treatment layer and the third treatment layer are not essential components and may be omitted. However, in order to effectively perform cleaning of the treatment layers, these gap layers are preferably provided. Alternatively, a gap layer may be disposed on the upstream side of the first treatment layer or disposed between the third treatment layer and the fourth treatment layer. By arranging a gap layer in this manner, the cleaning effect of a treatment layer adjacent to the gap layer can be further increased.

In the water treatment apparatuses of the embodiments, a single cleaning fluid supply unit is connected to a lower portion of the treatment layers of the main body so as to extend over the treatment layers. Alternatively, a plurality of cleaning fluid supply units may be connected to corresponding treatment layers.

The flow path of a fluid of the third embodiment may be formed in a zigzag manner in the vertical direction as in the second embodiment. In this manner, when a flow path of a fluid is formed in a zigzag manner in the vertical direction, the flow path can be further extended.

In the above embodiments, a description has been made of a structure in which the connecting portion of the cleaning fluid collecting unit has wall portions in regions connected to the first gap layer and the second gap layer. Alternatively, the fluid supply portion partition plate of the cleaning fluid supply unit may further have wall portions in regions connected to the first gap layer and the second gap layer. Alternatively, the connecting portion of the cleaning fluid collecting unit may have a mesh structure in the regions connected to the first gap layer and the second gap layer, and the fluid supply portion partition plate of the cleaning fluid supply unit may have wall portions in the regions connected to the first gap layer and the second gap layer.

When the fluid supply portion partition plate of the cleaning fluid supply unit has wall portions in the regions connected to the first gap layer and the second gap layer in this manner, the cleaning fluid A easily flows from lower portions of the respective treatment layers. Thus, in particular, the cleaning effect of lower portions of the particle layers is increased.

### INDUSTRIAL APPLICABILITY

As described above, according to the water treatment apparatus of the present invention, the structure for cleaning treatment layers is simple, and thus the cleaning time of the treatment layers can be reduced. Accordingly, the water treatment apparatus of the present invention and the water treatment method using the apparatus can efficiently perform a separation treatment of an oil-water mixed liquid containing various suspended substances in addition to oil. Thus, the water treatment apparatus of the present invention and the water treatment method using the apparatus can be suitable for use in production facilities such as factories and oilfields.

### REFERENCE SIGNS LIST

1, 2, 3 water treatment apparatus
10 cleaning fluid supply unit
10a introduction pipe
11 cleaning fluid collecting unit
11a collection pipe
21 first treatment layer
21a first particle
21b first space
22 second treatment layer
22a second particle
22b second space
23 third treatment layer
23a third particle
23b third space
24 first gap layer
25 second gap layer
26 fourth treatment layer
27 header portion
31 first partition plate
31a first wall portion
32 second partition plate
32a second wall portion
33 third partition plate
33a third wall portion
34 fourth partition plate
34a fourth wall portion
35 fifth partition plate
35a fifth wall portion
36 sixth partition plate
41 supply pipe
41a partition plate
42 discharge pipe
51, 52, 53, 54, 55, 56 partition plate
51a, 52a, 53a, 54a, 55a, 56a wall portion
60 partition plate
60a wall portion
61 connecting portion
61a wall portion
100, 200, 300 main body
X untreated liquid
Y treated liquid
A, Z cleaning fluid

1: A water treatment apparatus including a tubular main body disposed in a lateral direction, in which an untreated liquid is supplied from one end side of the main body in an axial direction, and a treated liquid is discharged from another end side thereof, the water treatment apparatus comprising:
a cleaning fluid supply unit that is connected to a lower circumferential surface of the main body and that supplies a cleaning fluid to an inside of the main body; and
a cleaning fluid collecting unit that is connected to an upper circumferential surface of the main body and that collects the cleaning fluid from the inside of the main body,
wherein the main body includes a plurality of treatment layers which are partitioned along the axial direction and in which a plurality of particles are enclosed.

2: The water treatment apparatus according to claim 1, wherein the treatment layers have spaces above the particles.

3: The water treatment apparatus according to claim 2, wherein the spaces of the treatment layers are separated from each other by a wall portion that does not allow a fluid to permeate.

4: The water treatment apparatus according to claim 1, wherein a flow path of a fluid of each of the treatment layers to an adjacent treatment layer is formed in a zigzag manner in a vertical direction.

5: The water treatment apparatus according to claim 1, wherein the treatment layers are inclined with respect to the axial direction of the main body.

6: The water treatment apparatus according to claim 1, further comprising a gap layer which is disposed between the treatment layers and in which no particles are enclosed.

7: The water treatment apparatus according to claim 1, wherein an introduction pipe that introduces the cleaning fluid into the cleaning fluid supply unit is connected to one of an untreated liquid supply side and a treated liquid discharge side of the main body, and a collection pipe that collects the cleaning fluid from the cleaning fluid collecting unit is connected to the other of the untreated liquid supply side and the treated liquid discharge side of the main body.

8: The water treatment apparatus according to claim 1, wherein the untreated liquid contains oil and a suspended substance, and the oil and the suspended substance are separated from the untreated liquid.

9: A water treatment method comprising:
a step of supplying an untreated liquid to the water treatment apparatus according to claim 1, and discharging a treated liquid.
